(19) United States
(12) Patent Application Publication
(10) Pub. No.: US 2016/0231166 A1
(43) Pub. Date: Aug. 11, 2016

(54) WEIGH MEASURING SCALES FOR BAGGAGE

(71) Applicant: NEERAJ MALHOTRA, RICHARDSON, TX (US)

(72) Inventor: NEERAJ MALHOTRA, RICHARDSON, TX (US)

(21) Appl. No.: 14/941,568

(22) Filed: Nov. 14, 2015

Related U.S. Application Data
(60) Provisional application No. 62/114,483, filed on Feb. 10, 2015.

(51) Int. Cl. G01G 19/52

(52) U.S. Cl. CPC G01G 19/52

(57) ABSTRACT

A weigh measuring system that is in-built into a baggage or shipment box. The system deploys one or more sensors to collect weight measurements and sends the information to a micro-controller. The micro-controller applies a software algorithm to convert raw readings into appropriate weigh reading. The result is displayed either on LCD, touch screen(s), analog meters. Using communication module(s) weigh measuring system transmits results to external devices such as smart phone, table computer, desktop/laptop computer, mobile phones or any devices which support radio frequency communications like Bluetooth LE, WIFI or NFC.

With additional sensors to identify orientation of the baggage or shipment box, the system can activate appropriate sensor(s) and display unit(s). The software application (apps) provides user interface for configuring system settings and reading weigh measurements on external devices like smart phone, table computer, desktop/laptop computer, mobile phones. The system is not restricted to travel gears for travellers but widely applicable to shipment boxes or containers as well used by shipment/courier companies or individuals.

### CROSS-REFERENCE TO RELATED APPLICATIONS

This application claims priority to U.S. Provisional Patent Application No. U.S. 62/114,483 entitled “WEIGH MEASURING SCALES IN-BUILT OR ASSEMBLED WITHIN BAGGAGE” filed Feb. 10, 2015, the entire contents of which is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to a system that measures weigh of travel bags, shipment box or containers. More specifically, the present invention is in the technical field of travel baggage, luggage items, shipment box or containers.

Most public transports such as airlines, trains or road transports impose some weight limits on all and individual baggage(s) carried by a passenger. The baggage could be the one that is checked-in or ones that are carried by the passengers travelling through airlines or the ones that are used by shipment carriers.

To avoid penalties for exceeding maximum allowed limits for individual bags, travellers usually weigh their baggage at home on standard weight scales. Then those bags are weighed again at terminals where a fee may or may not be imposed by carriers depending on weigh limits. There are many such scales available in market today to weigh baggage at home but none of them is user friendly as far as convenience is concerned. Broadly there are two types of weigh scales in market, used for weighing baggage at home; handheld scale and floor based scales. Handheld scale works by attaching the bag to the scale's hook and then lifting the scale with hands. Floor based scales work by lifting & placing baggage on a weight scale platform.

### BRIEF SUMMARY OF THE PRESENT INVENTION

The present invention comprises of a weigh measuring scale inbuilt within a travel baggage or any shipment item. In some implementations termed as factory fit-outs, the invention can be in-built within a new travel baggage or a shipment container by their manufacturer. While on other hand, the weigh system can be provided as an external module (termed as non factory fit-outs) that can be assembled with a used baggage/container by individuals. The invention includes a weigh measuring system, which when assembled within a baggage weighs the baggage and items placed inside it and provides readings to the user without lifting it.

The measuring system comprises of display unit(s) like LCD, Touch screen(s) or Analog meter(s) to indicate the measured weight of baggage. The system draws its power preferably from a rechargeable battery or ordinary battery(s) (AAA/AA) or via a USB port.

The invention preferably comprises of communication subsystem(s) to transmit data and configuration information between measuring units and a smart phone, tablet computer, laptop computer, desktop computer, mobile devices or any device over wired channels of communication like USB cable or via wireless communication protocols such as Bluetooth, WIFI Internet or Near Field Communication (NFC) channels. The present invention preferably sends and receives data and configuration information to and from mobile devices or computers via software applications.

The system allows user to control various configuration settings such as change the units of measurements from kilograms to pounds via switch buttons on the measuring device or touch screen controls or remotely control via a smart phone, tablet computer, laptop computer, desktop computer, mobile devices or any device supporting Bluetooth/Near field communication/WIFI internet. The invention comprises of one or more sensors assembled in a circuit and mounted in order to measure weights sending over to central control unit. The sensor(s) are assembled in such a way so as to measure weigh of a baggage in vertical as well as horizontal positions of the baggage.

Details of one or more implementations are set forth in the accompanying drawings and the description below. Other features, aspects and potential advantages will be apparent from the description and drawings, and from the claims.

### BRIEF DESCRIPTION OF THE DRAWINGS

FIG. 1 illustrates an example of vertical implementation of present invention;

FIG. 2 illustrates rear view of implementation FIG. 1;

FIG. 3 illustrates example of implementation where wheels have inbuilt weigh sensors and plugged into the base control unit attached to baggage bottom;

FIG. 4 illustrates example of vertical implementation with sensors & control unit installed at inner bottom of the baggage;

FIG. 5 illustrates example implementation where sensors are attached between base of baggage and wheel(s);

FIG. 6 illustrates a perspective top view of FIG. 1 with display unit installed on exterior wall of baggage;

FIG. 7 is a block diagram, showing example components that can implement the features and processes of present invention;

FIG. 8 illustrates example of horizontal implementation in addition to vertical implementation in a baggage with sensors & display unit(s) installed at respective points;

FIG. 9 illustrates an example of add-on module (non factory fit-outs) to be attached with an used baggage by an individual;

FIG. 10 illustrates an example implementation using load cell as weigh sensor;

### DETAILED DESCRIPTION OF THE INVENTION

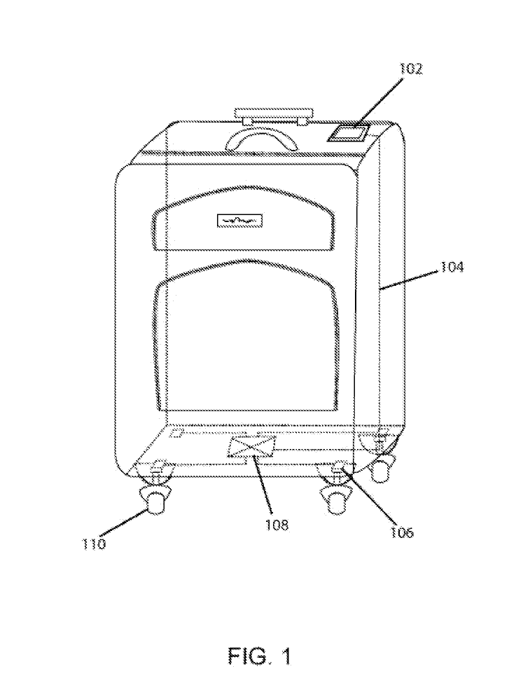

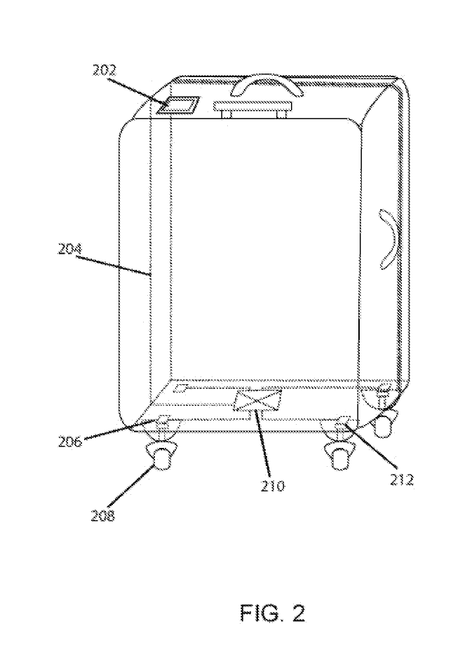

Referring now to the invention in more detail, in FIG. 1, there is shown a travel baggage in vertical implementation having a display unit 102 mounted over the exterior top of the baggage held upright above the floor on its wheels 110. Each wheel is assembled with a weigh-measuring sensor 106. All four weigh measuring sensors are connected to the control unit 108 which receives readings from sensors and shows measured reading on the display unit 102 connected through cables 104. For two wheels baggage, the sensor(s) can optionally be mounted at wheels or also at the base of the baggage. FIG. 2 is rear view of FIG. 1 and has same components.

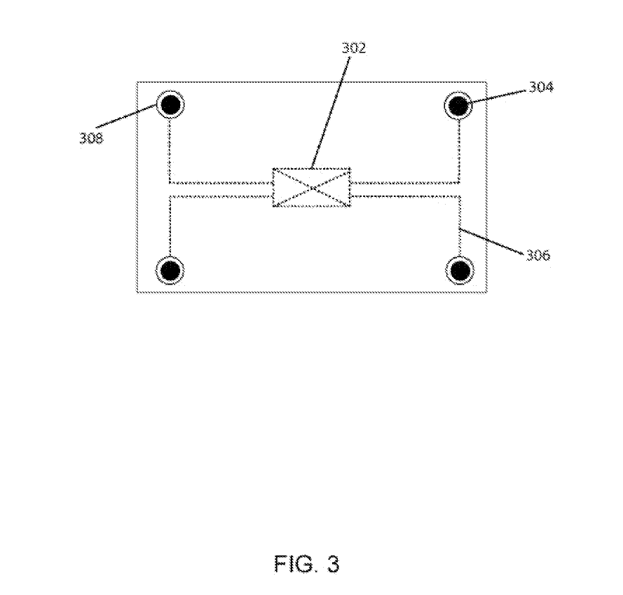

Referring now to FIG. 3, which is an example showing implementation where wheels 308 have in-built sensors 304 and connecting cables 306 to be plugged into the control unit 302.

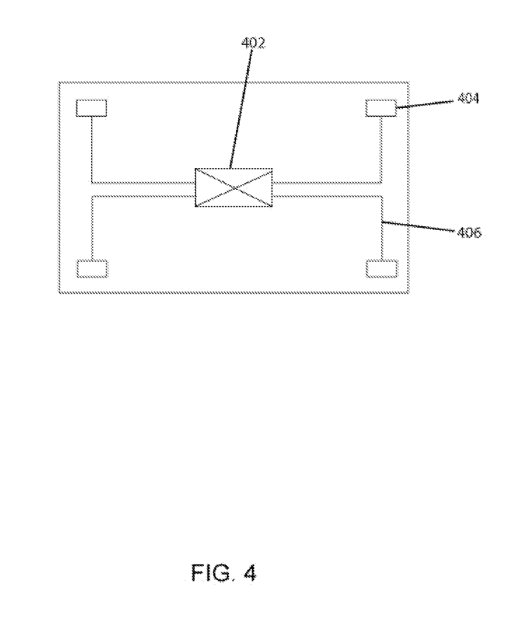

Referring now to FIG. 4, which is an example of present invention, showing an implementation where sensor(s) 404 & control unit 402 are installed at inner bottom of baggage base and connected through cables 406.

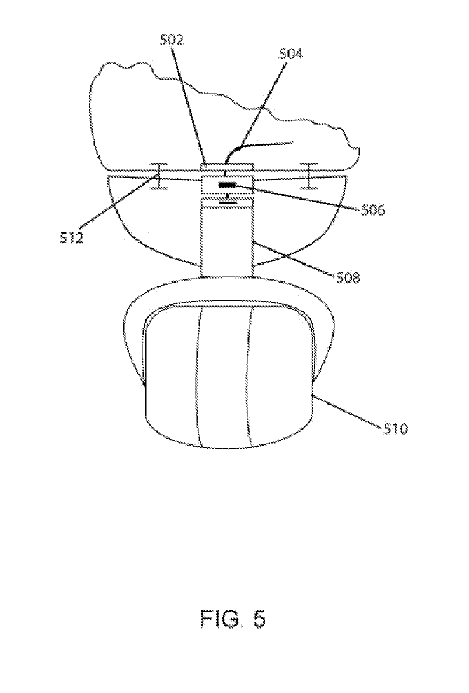

Referring now to FIG. 5, which is an example implementation of present invention with sensor(s) 506 installed between wheel(s) 510, 508 and base 502 of the baggage. The wheels are generally bolted 512 to the base for extra strength. The electrical cables 504 connect the sensor 506 to the control unit. All wheels of the baggage preferably follow similar assembly.

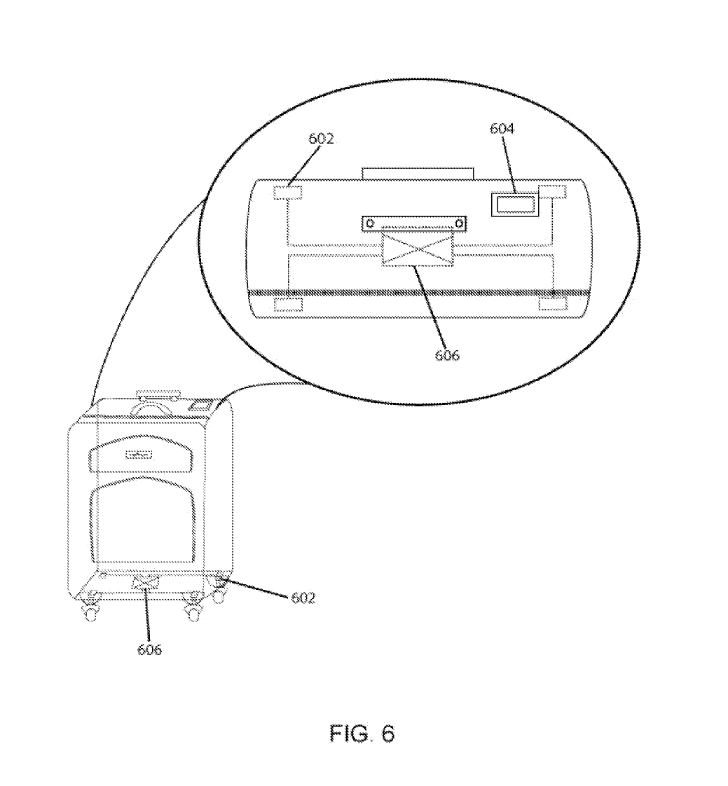

Referring now to FIG. 6, which is the top view of present invention, showing an example implementation of how exterior top of baggage may look like with display unit 604 mounted over exterior wall of a baggage. This view also depicts how overall assembly would look like for a baggage with in-built or assembled weigh-measuring scale having sensor(s) 602 & control unit 606. Optionally baggage may have one or more display units and additional sensors as described later in this section.

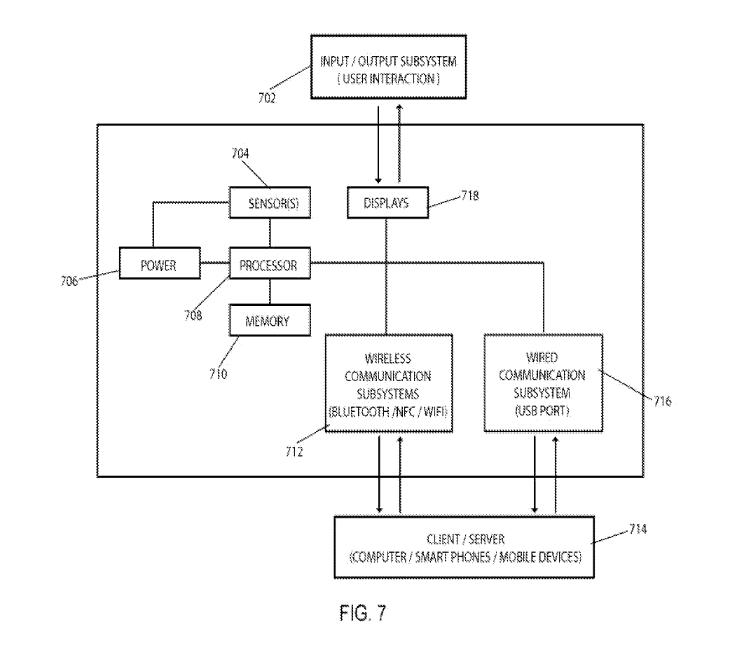

Moving to FIG. 7, which is a block diagram indicating components that can implement the features and processes of present invention. The weigh measuring system is comprised of a power module 706 with optional sources as rechargeable battery or AAA/AA battery cells or power through USB port. A user would interact with weigh measuring system via a variety of input/output control subsystems 702 such as switch(s), touch screen controls, or via external devices such as smart phone, tablet, computer or mobile devices. The software application would allow user to configure the units of measurement and other settings per their likings.

Still referring to FIG. 7, the control unit includes various components like memory 710, processor 708 and communication subsystems/modules. The processor gathers information from sensor(s) 704 and after munching the information & running it through an algorithm, shows results on respective display unit(s) 718. The processor 708 also interacts with communication subsystems to send and receive information between control unit and external devices 714 like a smart phone, tablet computer, laptop computer, desktop computer, mobile devices in client/server mechanism 714 as shown in FIG. 7.

Still referring to FIG. 7, in some implementations, the weigh measuring system also allows sending & receiving of data/configuration to or from computer or mobile devices, preferably via a software application (‘app’) installed on devices. However, optional modes of communication with external devices may include radio frequency e.g. Bluetooth, near field communication or WIFI Internet for wireless communication subsystems 712 and over connected USB ports for wired communication subsystems 716.

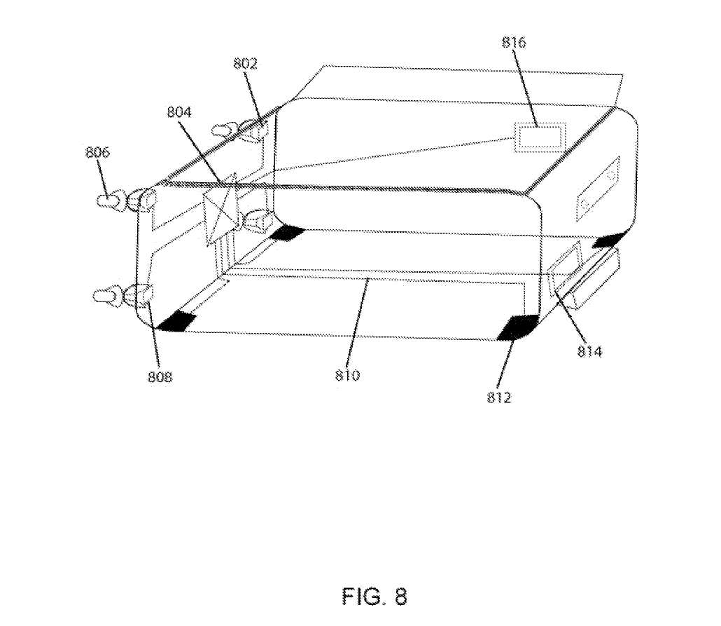

Referring now to FIG. 8 which illustrates the horizontal implementation of weigh measuring system installed in such a way so as to allow users to read weigh while they are still filling the baggage. A display unit 816 is installed on inner walls of the baggage in this implementation. In this implementation, as the baggage is horizontally placed on the floor or surface, one or more sensor(s) 812 are installed at bottom surface (inside or outside) of the baggage through cables 810 to control unit 804. This allows user to measure weight in real time while placing items inside the baggage and add/remove items accordingly. The display unit 816 mounted inside wall optionally be turned On/Off automatically via additional sensors (e.g. orientation or pressure sensor) or manually controlled by the user. As seen in FIG. 8, the sensor(s) 802 are also installed between baggage base 808 and wheels 806 to the control unit 804 with an externally mounted display unit 814. This is an example of combination of both implementations where baggage can be measured in vertical as well in horizontal orientations.

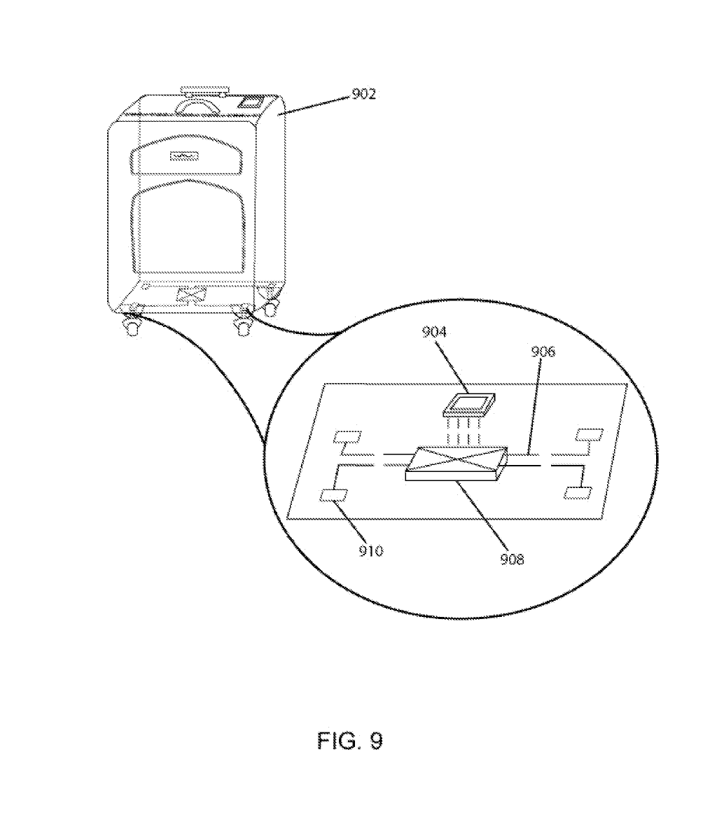

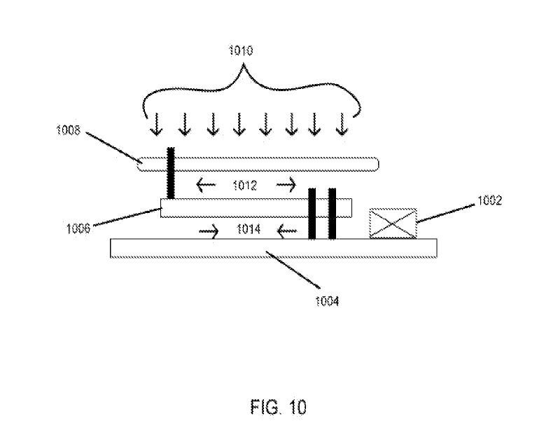

Referring now to FIG. 9, which is an example of present invention provided as an add-on module (non factory fit) for existing baggage 902. As depicted earlier that weigh measuring system has two different assemblies which are; factory fit outs (in-built) & non-factory fit outs (add-on). FIG. 10 illustrates latter type of implementation i.e. non-factory fit outs. The add-on module preferably includes sensor(s) 910, a control unit 908 and display unit(s) 904 with connecting wires 906. The present invention can be attached to an existing baggage 902 by an individual and used same way as an in-built system.

There are many types of sensors which can be used to measure weight in weigh measuring scale system, such as; load cells, strain gauge, force sensitive resistors (FSRs), pressure sensitive resistors, etc. FIG. 10 illustrates an example implementation using a single load cell 1006. When a force 1010 is applied on certain points on load cell, its resistance changes. The way it works is that the upper surface of load cell expands 1012 while lower surface contracts 1014. This slight expansion and contraction of material causes change in resistance which is measured by weigh measuring control unit 1002. The base 1004 and top 1008 panels are used to support the load cell while also direct force at optimal points on it. Load cell, strain gauge, FSRs and pressure sensitive resistors have same underlying functional principles.

The advantage of the present invention include, without limitation, that it is portable and exceedingly easy to weigh baggage. It is easy to move around with these devices into a house or office or even travel to distant places, because they are relatively small & lightweight. As these devices are in-built into the baggage, there is no need to carry additional weigh scales while travelling and no need to buy inconvenient weigh scales. Using this device requires a single person, as there is no need to lift a baggage in order to measure it. Furthermore, since the weigh scale is now in-built or assembled into the baggage, there is no need to worry about forgetting scales at home while travelling.

In broad embodiment, the present invention is a weigh-measuring scale in-built or assembled within a baggage or shipment containers or boxes.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

Having described my invention, I claim:

1. A weigh measuring system comprising of:
a. an electronic circuit to read weight from sensors;
b. one or more sensors to measure weigh;
c. display unit(s) e.g. LCD or touch screen or analog meters to read measured weight and to configure settings;
d. micro-processor(s) to control weigh measuring system and configure settings such as units of measurement (grams, kilograms or pounds) and interaction with subsystems;
e. manual switch(s) or additional sensors to turn system ON/OFF;
f. memory to persist user configuration settings;
g. communication module(s) for wireless or wired transmission of data and configuration information between system and a smart phone, tablet computer, laptop computer, desktop computer, mobile devices or any device supporting communication module;
h. a power module providing energy to weigh measuring system;
i. software program to control weigh measuring system and to fetch or store readings & configuration settings;

2. A baggage/shipment item with in-built or assembled weight scale system as recited in claim 1, wherein said weight measuring system is powered by rechargeable battery(s) or USB cable or standard AAA/AA batteries.

3. A baggage with in-built or assembled weight scale system as recited in claim 1, wherein weigh sensors are optionally assembled between wheel(s) and base of said baggage.

4. A baggage/shipment item with in-built or assembled weigh scale system as recited in claim 1, wherein sensors are installed in such a way so as to measure its weigh in real time while baggage or shipment item is being filled up by the user. In this implementation, the display unit(s) are optionally mounted inside the baggage/shipment item for convenient reading by the user.

5. A baggage/shipment item with in-built or assembled weight scale as recited in claim 1, wherein one or more load cells, strain gauge(s), pressure, force sensitive resistors (FSRs) or similar sensors can be used individually or in combination as weigh sensor(s).

6. A baggage/shipment item with in-built or assembled weight scale as recited in claim 1, wherein display unit(s) like LCD(s) or touch screen(s) or analog meter(s), are attached to interior or exterior walls of said baggage or shipment item.

7. A baggage with in-built or assembled weigh scale system as recited in claim 1, wherein weigh measuring system senses the orientation of the baggage and then automatically turn on the respective display unit(s) e.g. activate internal display unit when baggage is been filled up or external display unit when baggage is sealed and placed on it's wheels.

8. A baggage/shipment item with in-built or assembled weight scale as recited in claim 1, wherein said weight measurement system connects wirelessly via Bluetooth or WIFI Internet or Near Field Communication (NFC) or any wireless transmission protocol, to external devices like smart phone, tablet computer, desktop computer, laptop computer, mobile devices, or any device supporting wireless communication modules.

9. A baggage/shipment item with in-built or assembled weight scale as recited in claim 8, wherein software applications are used to control and configure weigh measuring system.

10. A baggage/shipment item with in-built or assembled weigh scale system as recited in claim 1, wherein said weigh measuring system provides wired communication subsystem(s) such as USB port(s) to connect to a smart phone, computer or mobile devices and used to operate & configure settings via software application.

11. A baggage with in-built or assembled weight scale as recited in claim 1, wherein said baggage includes travel bags, handbags, suitcase, laptop bags, briefcase, luggage or any travel gears with factory fit or non-factory fit weigh measuring system, used by passengers.

12. A baggage with in-built or assembled weight scale as recited in claim 1, wherein said baggage includes packing boxes or containers with factory fit or non-factory fit weigh measuring system, used by shipment or courier providers.

13. A weigh measuring system as recited in claim 1, wherein said system is available as an add-on module and can be attached to an existing or used baggage (non factory fits) by customer.

14. A weigh measuring system as recited in claim 1, wherein baggage wheels optionally have in-built weigh sensor(s) to be connected to a control unit.
